(19) United States
(12) Patent Application Publication
(10) Pub. No.: US 2006/0132533 A1
(43) Pub. Date: Jun. 22, 2006

(54) Liquid ejecting apparatus

(75) Inventor: Seiji Mochizuki, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/281,731

(22) Filed: Nov. 18, 2005

(30) Foreign Application Priority Data
Nov. 19, 2004 (JP) P2004-336099

(51) Int. Cl. B41J 2/165

(52) U.S. Cl. 347/30

(57) ABSTRACT

A liquid ejecting apparatus comprising: a liquid ejection head capable of ejecting a liquid droplet from a nozzle opening provided in a nozzle surface; a capping member capable of sealing the nozzle opening with a capping member being in close contact with a nozzle surface; a flushing control unit for idly ejecting a liquid droplet from the nozzle opening toward the capping member; a pump mechanism that communicates with the capping member through a liquid channel; and a suction control unit for effecting control of sucking liquid from inside the capping member through the liquid channel by actuating the pump mechanism, wherein the suction control unit is capable of executing a light suction mode which is executed during an ejection operation and a total-amount suction mode which is executed before effecting sealing by the capping member after the ejection operation, wherein a suction amount in the total-amount suction mode is set to not less than such an amount as to be capable of discharging liquid in the capping member and liquid inside the liquid channel, and wherein a suction amount in the light suction mode is set to be smaller than the suction amount in the total-amount suction mode.

### BACKGROUND OF THE INVENTION

1. Technical Field of the Invention

The present invention relates to a liquid ejecting apparatus in which after a flushing operation for idly ejecting droplets of a liquid forcibly, the ejected droplets are discharged by a pump mechanism.

2. Description of the Related Art

As a typical liquid ejecting apparatus which has an ejection head capable of ejecting liquid and ejects various liquids from this ejection head, it is possible to cite, for example, an image recording apparatus such as an ink jet printer for performing recording by allowing ink droplets to be ejected onto and landed on recording paper or the like serving as an ejection object (recording medium). In addition, in recent years, the liquid ejecting apparatus is applied not only to this image recording apparatus but also to various manufacturing apparatuses. For example, in apparatuses for manufacturing displays such as liquid crystal displays, plasma displays, organic EL (electro luminescence) displays, FED's (field emission displays), or the like, a liquid ejecting apparatus is used for ejecting various liquid materials such as a colorant, an electrode, and the like to an image forming area, an electrode forming area, and the like.

To cite the above-described ink jet printer (hereafter abbreviated simply as the printer) by way of example, this printer is comprised of, among others, a recording head for ejecting ink droplets, a head moving mechanism for moving this recording head in a main scanning direction, and a recording medium feeding mechanism for effecting sub scanning by feeding a recording medium such as recording paper in a direction orthogonal to the main scanning direction. The printer is constructed such that in a state in which the recording medium and a nozzle forming surface (nozzle plate), in which nozzle openings of the recording head are provided in the form of rows, are opposed in parallel, the ejection of ink droplets in the main scanning by the recording head and the feeding of the recording medium (sub scanning) are sequentially repeated so as to effect the recording of an image or the like on the recording medium.

The free surface (meniscus) of the ink in the nozzle openings of the recording head is exposed to the air during the recoding operation (a kind of ejecting operation). For this reason, in the nozzle openings which practically do not eject ink droplets during the recording operation, a solvent gradually evaporates with the lapse of time and the viscosity of the ink increases, possibly resulting in faulty ejection, including the occurrence of a deviation in the flying direction of the ink droplets and the impossibility of ejection of the ink droplets.

To prevent this faulty ejection, in this type of printer, a flushing operation is performed for idly ejecting ink droplets forcibly irrespective of the recording operation. During the execution of this flushing operation, a capping member, for example, is used as a member for receiving the ejected ink droplets. Further, as the flushing operation is performed, the ink stored in the capping member is subjected to a suction operation by a pump mechanism (a kind of suction device) connected to the capping member, and is discharged.

However, if the ink remains in the capping member or the pump mechanism over a long period of time after the above-described suction operation, the ink becomes dry and solidifies, possibly resulting in the occurrence of malfunctions such as a decline in the suction force of the pump mechanism and the closure of a liquid channel through which the ink in the pump mechanism is discharged. In addition, as the ink remaining in the pump mechanism flows backward and returns to inside the capping member, possibly resulting in the occurrence of faulty ejection due to the adhesion of the ink to the nozzle surface.

To prevent such malfunctions, an ejecting apparatus has been proposed in which after performing the flushing operation for idly ejecting ink droplets into the capping member, the ink remaining in the capping member and the pump mechanism is discharged by the suction operation, thereby eliminating the ink causing the aforementioned malfunctions from inside the suction mechanism (e.g., the capping member and the pump mechanism) (e.g., JP-A-8-39830).

In recent years, with this type of printer, there is a tendency to increase the content of the colorant of the ink to improve the image quality and to use waterproof ink to improve water resistance. For this reason, the viscosity of the ink is likely to increase in comparison with the conventional ink, there is a need to perform the flushing operation frequently and increase the amount of ink which is idly ejected during the flushing operation.

In addition, with this type of printer, the ink in the vicinities of the nozzle openings is agitated by subjecting the meniscus (the free surface of the ink exposed at the nozzle opening) to microvibration to such an extent that the ink is not ejected, so as to suppress the increase in the ink viscosity. This microvibration includes microvibration during printing which is effected when the recording head is being moved at a constant speed during the recording operation and microvibration during nonprinting which is effected when the recording head is being moved with acceleration or deceleration. Since the microvibration during nonprinting does not exert an effect on the ejection, the microvibration during nonprinting is able to impart stronger vibrational energy to the meniscus than the microvibration during printing, so that its effect of suppressing the increase in ink viscosity is higher.

Incidentally, with large-print type printers which are increasing in recent years, since the print area becomes large in correspondence with the print medium, the proportion of the constant-speed movement of the recording head during the recording operation tends to increase more than in the ordinary printers. Accordingly, since the proportion in which the microvibration during nonprinting is imparted becomes smaller than in the ordinary printers, the effect of suppressing the increase in ink viscosity due to the microvibration operation becomes low. Accordingly, with the large-print type printers, it is necessary to perform the flushing operation more frequently than in the ordinary printers.

Thus, in conjunction with an increase in the amount of ink which is idly ejected during the flushing operation and an increase in the number of times of execution of the flushing operation, the amount of ink stored in the capping member also increases, and the number of times of execution of the suction operation which is effected after the flushing operation also increases inevitably. Namely, the time duration of execution of the suction operation tends to increase.

In addition, there are large-print type printers in which the channel up to a waste liquid storing member in which the ink discharged by the suction operation is finally stored is long, so that there are cases where the time duration of execution of a single suction operation becomes longer than in the ordinary printers.

As described above, the time duration of execution of the suction operation tends to increase, and the deterioration of the pump mechanism due to an increase in the amount of its operation is likely to advance correspondingly. Therefore, there is a possibility of the occurrence of a problem such as the failure of the pump mechanism even in its use for a short period of time.

### SUMMARY OF THE INVENTION

The invention has been devised in view of the above-described circumstances, an its object is to provide a liquid ejecting apparatus which makes it possible to prevent in advance malfunctions which occur due to the remaining of liquid such as ink in the pump mechanism over a long period of time, and which makes it possible to suppress the deterioration of the pump mechanism.

The liquid ejecting apparatus in accordance with the invention has been proposed to attain the above object, and is characterized by comprising:

a liquid ejection head capable of ejecting a droplet of a liquid from a nozzle opening provided in a nozzle surface;

capping member capable of sealing a tray-like capping member in close contact with the nozzle surface;

flushing control unit for idly ejecting a droplet from the nozzle opening toward the capping member;

a pump mechanism communicating with the capping member through a liquid channel; and

suction control unit for effecting control for sucking the liquid from inside the capping member through the liquid channel by actuating the pump mechanism,

wherein the suction control unit is capable of executing a light suction mode which is executed during an ejection operation and a total-amount suction mode which is executed before effecting sealing by the capping member,

wherein the amount of suction in the total-amount suction mode is set to not less than such an amount as to be capable of discharging liquid in the capping member and liquid inside the liquid channel, and

wherein the amount of suction in the light suction mode is set to be smaller than the amount of suction in the total-amount suction mode.

It should be noted that the phrase “such an amount as to be capable of discharging liquid in the capping member and liquid inside the liquid channel” in the invention means an amount which combines the volume in the capping member and the volume inside the liquid channel.

According to the above-described construction, the suction control unit is capable of executing a light suction mode which is executed during an ejection operation and a total-amount suction mode which is executed before effecting sealing by the capping member, the amount of suction in the total-amount suction mode is set to not less than such an amount as to be capable of discharging the liquid in the capping member and the liquid inside the liquid channel, and the amount of suction in the light suction mode is set to be smaller than the amount of suction in the total-amount suction mode. Therefore, the amount of work of the pump mechanism in a single suction operation during the ejection operation is alleviated, and the deterioration and the like of the pump mechanism can be suppressed. In addition, since the liquid remaining in the capping member and inside the liquid channel can be discharged in the total-amount suction mode, it is possible to prevent malfunctions such as a decline in the suction force of the pump mechanism and the closure of liquid channel. Furthermore, as the suction operation is executed in the total-amount suction mode before effecting sealing by the capping member after the completion of the ejection operation, the ink does not remain inside the liquid channel over a long period of time due to the standby state of the liquid ejecting apparatus or the turning off of the power supply. Therefore, it is possible to prevent malfunctions such as faulty ejection which can occur due to the adhesion of the liquid to the nozzle surface when the remaining liquid flows backward into the capping member.

It should be noted that the term “idle ejection” in the invention means the ejection of droplets onto a liquid receiving member such as the capping member irrespective of the ejection object such as a recording medium. In addition, the term “during the ejection operation” in the invention means while the ejection operation which is performed with respect to the ejection object is being executed.

In the above-described construction, the liquid ejecting apparatus may be preferably further comprise: a liquid storage amount calculating unit for calculating an amount of liquid stored in the capping member under control by the flushing control unit, wherein the suction control unit executes the light suction mode in a case where the amount of liquid calculated by the liquid storage amount calculating unit during an ejection operation has reached a predetermined amount, and wherein the predetermined amount is set to not more than the amount of suction in the light suction mode.

According to the above-described construction, the liquid ejecting apparatus further comprises liquid storage amount calculating unit for calculating an amount of liquid stored in the capping member under control by the flushing control unit, and the suction control unit executes the light suction mode in a case where the amount of liquid calculated by the liquid storage amount calculating unit during an ejection operation has reached a predetermined amount. Therefore, it is possible to reduce the number of times of execution of the suction operation in the light suction mode. Accordingly, the amount of work of the pump mechanism during the ejection operation can be reduced further, so that the deterioration of the pump mechanism can be suppressed further. In addition, since the predetermined amount is set to not more than the amount of suction in the light suction mode, the liquid remaining in the capping member can be discharged reliably.

In addition, in the above-described construction, the amount of suction in the light suction mode may be preferably set to not greater than the volume in the capping member. As a result, the amount of work of the pump mechanism in a single suction operation during the ejection operation can be reduced substantially, and the deterioration of the pump mechanism can be suppressed further.

### BRIEF DESCRIPTION OF THE DRAWINGS

FIG. 1 is a perspective view explaining the construction of a printer;

FIG. 2 is a side view of a carriage;

FIG. 3 is a partial cross-sectional view of a recording head;

FIGS. 4A and 4B are explanatory diagrams of a capping mechanism, in which FIG. 4A is a diagram explaining a retreated state, and FIG. 4B is a diagram explaining a sealed state;

FIGS. 5A and 5B are explanatory diagrams of the capping mechanism, in which FIG. 5A is a perspective view explaining a capping member, and FIG. 5B is a schematic diagram explaining the sealed state;

FIGS. 6A and 6B are explanatory diagrams of a tube pump, in which FIG. 6A is a diagram explaining the forwardly rotating operation, and FIG. 6B is a diagram explaining the reversely rotating operation;

FIG. 7 is a block diagram explaining an electric configuration of the printer;

FIG. 8 is a flowchart explaining processing from a flushing operation start until the completion of the suction operation; and

FIG. 9 is a flowchart explaining processing from the flushing operation start until the completion of the suction operation.

### DETAILED DESCRIPTION OF THE INVENTION

Hereafter, a description will be given of an embodiment of the invention. It should be noted that in the following description an example will be given of an image recording apparatus which is one form of the liquid ejecting apparatus, more particularly an ink jet printer (hereafter referred to as the printer).

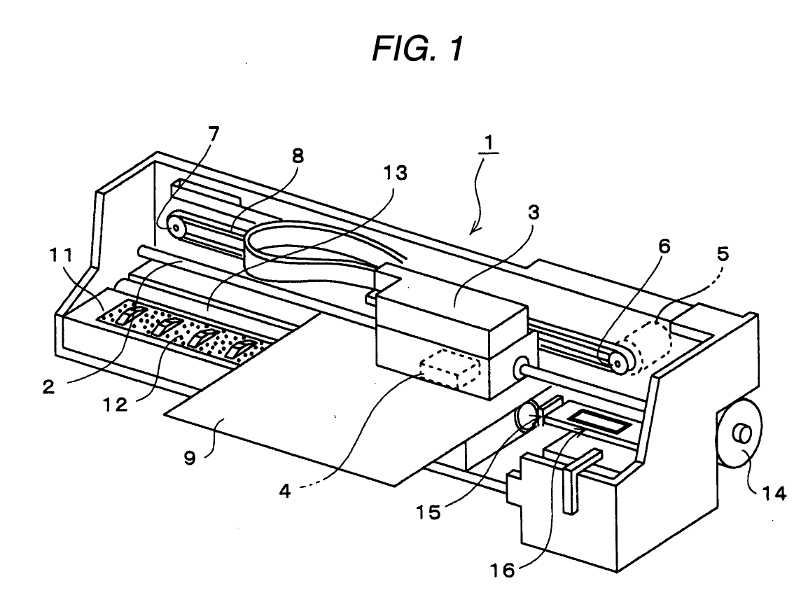

FIG. 1 is a perspective view explaining a basic construction of this printer 1. As shown in this FIG. 1, the print 1 has a carriage 3 mounted on a guide shaft 2, and a recording head 4 (a kind of liquid ejecting head in accordance with the invention) is attached to a lower surface thereof. In addition, a cartridge holder portion for detachably holding an ink cartridge (neither are shown) is provided inside this carriage 3. Since the carriage 3 is connected to a timing belt 8 stretched between an idle pulley 7 and a drive pulley 6 joined to a rotating shaft of a pulse motor 5, the carriage 3 moves in the widthwise direction (main scanning direction) of recording paper 9 by the driving of the pulse motor 5.

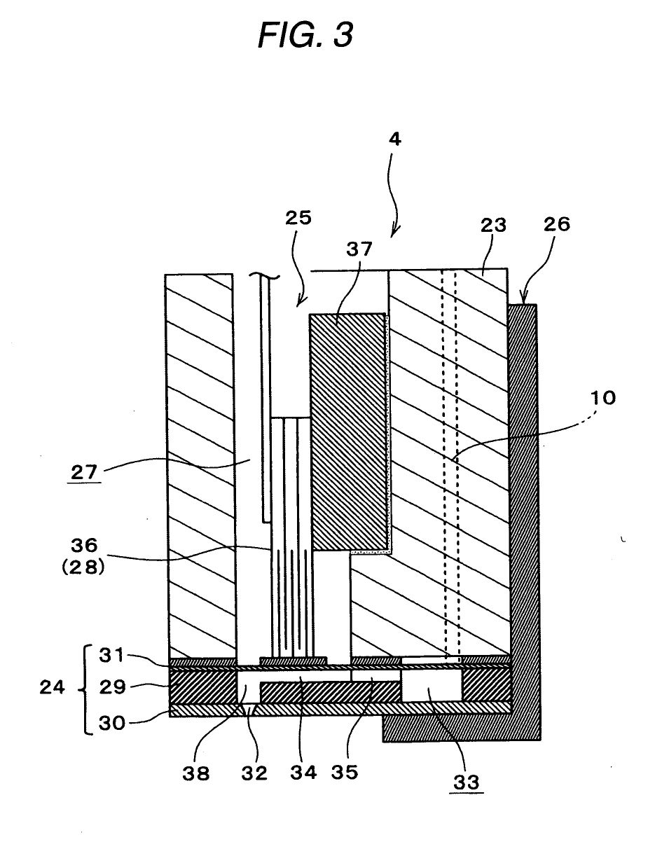

The aforementioned ink cartridge is a box-shaped member for storing ink (a kind of liquid in accordance with the invention). This ink is a liquid in which a colorant is dissolved or dispersed in an ink solvent. For example, a pigment or dye is used as the colorant, and water is used as the ink solvent. When this ink cartridge is loaded in the cartridge holder portion, an ink supplying needle (not shown) provided in the cartridge holder portion is inserted into the ink cartridge. Since this ink supplying needle communicates with an ink supplying path 10 (see FIG. 3) of the recording head 4, when the ink supplying needle is inserted, the ink inside the ink cartridge assumes a state in which it can be supplied to the interior of the recording head 4.

In addition, a platen 11 is provided below the guide shaft 2. This platen 11 is a plate-shaped member which supports the recording paper 9 from below. A liquid absorbing member 12 such as a sponge is disposed on this platen 11. Further, a paper feed roller 13 is disposed in parallel with the guide shaft 2 upstream of this liquid absorbing member 12 in the paper feeding direction. This paper feed roller 13 is rotated by a driving force from a paper feed motor 14 during the conveyance of the recording paper 9.

A home position is set at a position outside the platen 11 within the moving range of the carriage 3. In a standby state, the recording head 4 is positioned at this home position. At this home position, a wiper mechanism 15 for wiping the nozzle surface of the recording head 4 and a capping mechanism 16 capable of sealing the nozzle surface in a nonrecording state are disposed in such a manner as to be arranged side by side.

Next, a description will be given of the recording head 4. As shown in FIG. 3, the recording head 4 is comprised of a casing 23, a channel unit 24, a transducer unit 25, a head cover 26, and the like. The casing 23 is a synthetic resin-made, block-shaped member having therein an accommodating cavity 27 whose distal end and rear end are open, the channel unit 24 being joined to its front end face. In addition, the transducer unit 25 is accommodated in the accommodating cavity 27 in a state in which distal ends of respective piezoelectric transducers 28 are opposed to the distal end-side opening. Further, the ink supplying path 10 for allowing the ink supplying needle and the channel unit 24 to communicate with each other is provided on the lateral side of the accommodating cavity 27.

The channel unit 24 is comprises of a channel forming plate 29, a nozzle plate 30, and a resilient plate 31. The nozzle plate 30 is a thin plate-shaped member in which a multiplicity of (e.g., 180) nozzle openings 32 are provided in the form of rows at pitches corresponding to a dot forming density, and the nozzle plate 30 is formed by a stainless steel plate, for example. Nozzle rows are formed by the nozzle openings 32 provided in rows, and these nozzle rows are formed in a laterally juxtaposed form. An outer surface of this nozzle plate 30 functions as the nozzle surface in accordance with the invention. The following are formed in the aforementioned channel forming plate 29: a reservoir 33 into which the ink supplied through the ink supplying path 10 flows, pressure chambers 34 for generating an ink pressure necessary or ejecting ink droplets from the nozzle openings 32, and an ink supplying port 35 for allowing the reservoir 33 and the pressure chamber 34 to communicate with each other, and the like. The aforementioned pressure chamber 34 is a hollow portion which is elongated in a direction substantially orthogonal to the direction of the nozzle row, and the pressure chambers 34 are formed in the direction of the nozzle row and in a number corresponding to the nozzle openings 32. The ink supplying port 35 is a kind of liquid supplying pot, and although its depth is the same as that of the pressure chamber 34, its channel width is set to be sufficiently narrower than that of the pressure chamber 34. The aforementioned resilient plate 31 has a double structure in which an elastic body film is laminated on a supporting plate. Further, a portion corresponding to the reservoir 33 and a portion corresponding to the pressure chamber 34 are removed in the supporting plate.

In this channel unit 24, series of ink channels are formed each of which extends from the ink supplying path 10 to the nozzle opening 32 through the reservoir 33, the ink supplying port 35, the pressure chamber 34, and a nozzle communication port 38. In this series of ink channels, the portion from the ink supplying port 35 to the nozzle communication port 38 constitutes a separate ink channel provided for each nozzle opening 32.

The aforementioned transducer unit 25 is formed by a transducer group 36 constituted by the plurality of piezoelectric transducers 28 formed in the form of comb teeth, a fixing plate 37 to which a root portion of this transducer group 36 is joined, and so on. The respective piezoelectric transducers 28 making up this transducer group 36 are slit into extremely narrow widths of 50 μm to 100 μm, for example. In addition, each piezoelectric transducer 28 has its fee end portion located outwardly of an edge of the fixing plate 37, and is joined to the fixing plate 37 in a cantilevered state. Further, if the free end portion of the piezoelectric transducer 28 is extended and contracted in the longitudinal direction of the element, the diaphragm is pressed toward the pressure chamber 34 side or pulled toward the side away from the pressure chamber 34. As a result, the volume of the pressure chamber 34 fluctuates, so that the ink pressure within the pressure chamber 34 changes. It is possible to eject ink droplets by making use of this ink pressure. For example, if the pressure chamber 34 of a steady volume is suddenly contracted after being temporarily expanded, the ink inside the pressure chamber 34 is suddenly pressurized, so that an ink droplet is ejected from the nozzle opening 32.

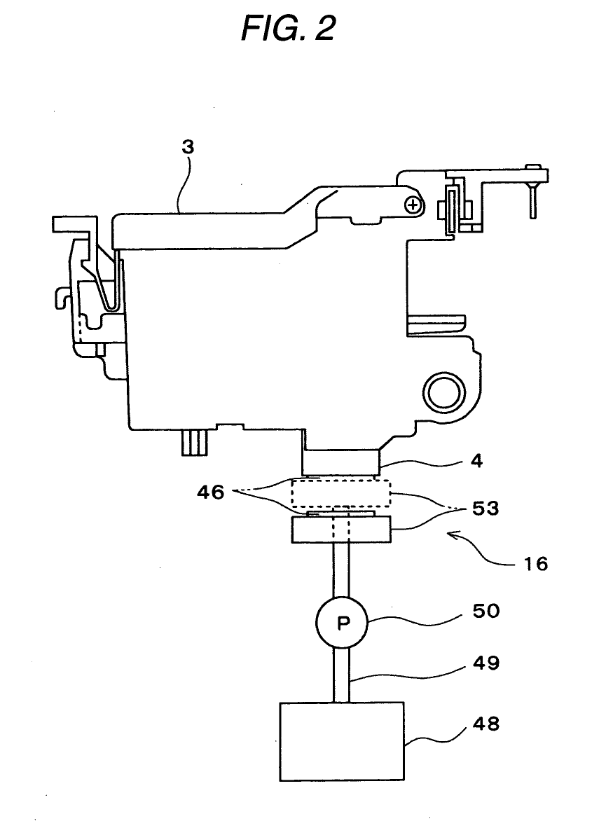

As shown in FIGS. 2 and 4 to 5, the capping mechanism 16 is formed by a tray-like capping member 46; a slider mechanism 47 which supports this capping member 46 and is movable obliquely vertically; a flexible liquid discharging tube 49 allowing a sealed hollow portion 45 and a waste liquid tank 48 to communicate with each other; and a tube pump 50 disposed midway in this liquid discharging tube 49.

The aforementioned capping member 46 is a tray-like member whose upper side is open and which has a rectangular bottom portion 51 and side wall portions 52 rising from peripheral edges of this bottom portion 51. The space surrounded by the bottom portion 51 and the side wall portions 52 serves as the sealed hollow portion 45. This capping member 46 is fabricated by molding an elastic member such as rubber into the form of a tray, and is attached to a slider member 53.

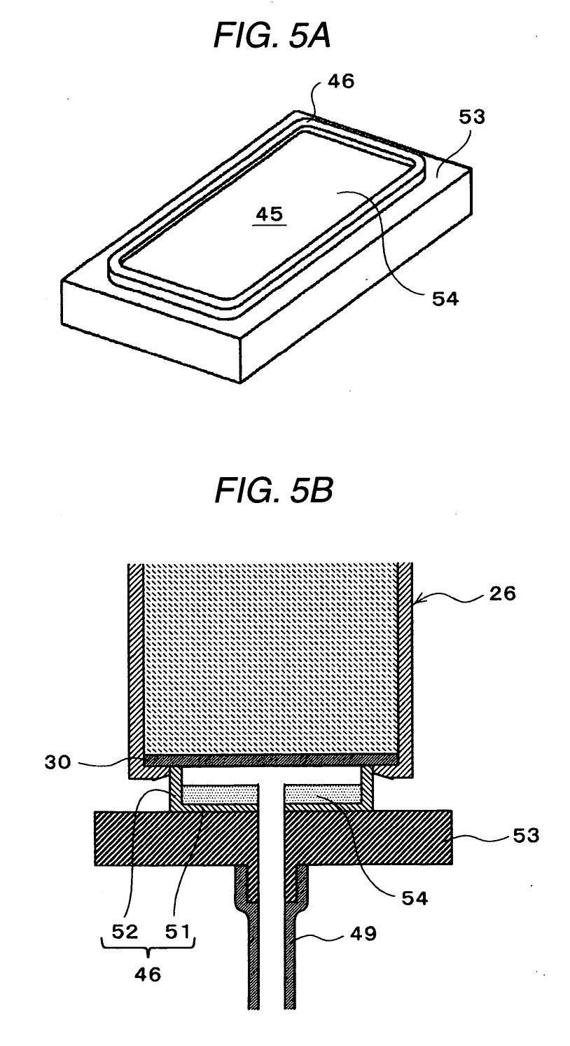

In addition, a liquid absorbing member 54 is fitted in the sealed hollow portion 45. This liquid absorbing member 54 is formed by a liquid absorbing material such as felt or sponge which is capable of absorbing the ink. The thickness of the liquid absorbing member 54 in this embodiment is formed to be smaller than the height of the sealed hollow portion 45. For this reason, as shown in FIG. 5B, the upper surface of the liquid absorbing member 54 is located lower than the nozzle surface in the state in which the nozzle surface is sealed by the capping member 46.

In addition, this capping member 46 is also used during the flushing operation for idly ejecting ink droplets irrespective of the recording operation (corresponding to the ejection operation in accordance with the invention), and is used as a member for receiving the ink droplets ejected from the recording head 4.

The aforementioned liquid discharging tube 49 is a member constituting an ink discharging path, and its inner space serves as a kind of liquid channel in accordance with the invention. In this embodiment, this liquid discharging tube 49 is formed by a silicone tube having high chemical resistance and high elasticity.

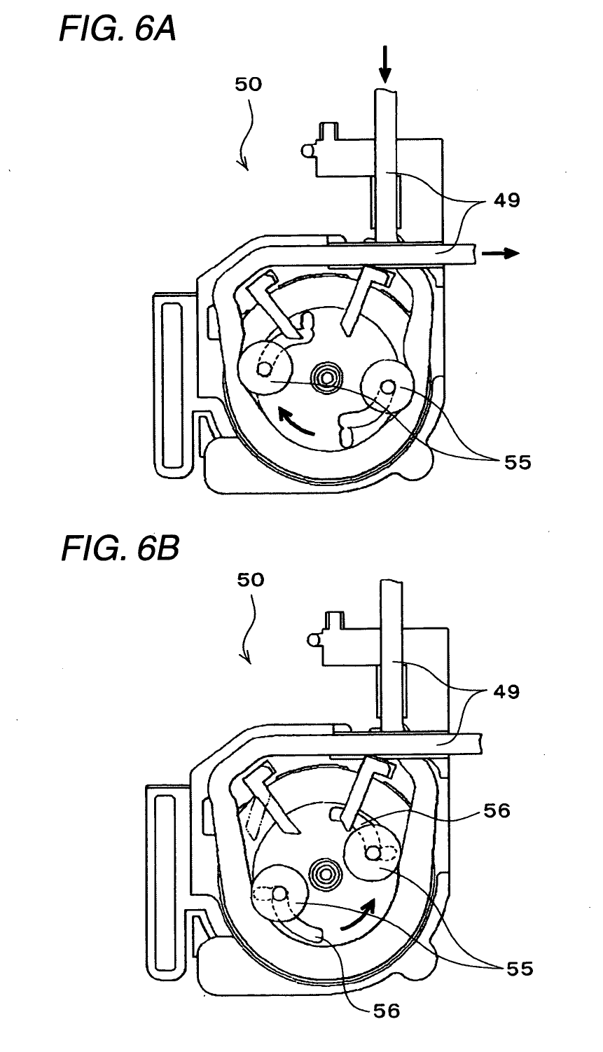

The aforementioned tube pump 50 has the paper feed motor 14 as its driving source, and makes up the pump mechanism together with this paper feed motor 14. Namely, an unillustrated power transmission mechanism is interposed between the tube pump 50 and the paper feed motor 14, and the torque of the paper feed motor 14 is transmitted to the tube pump 50 through this power transmission mechanism. Further, this tube pump 50 is a so-called “squeeze” type pump in which the air and the liquid inside the liquid discharging tube 49 are fed out by squeezing as the liquid discharging tube 49 is clamped and crushed by a pair of rollers 55, and the rollers 55 are moved along the liquid discharging tube 49 in this state, as shown in FIG. 6A. In this tube pump 50, a negative pressure can be imparted to the interior of the sealed hollow portion 45 by moving the rollers 55 from the sealed hollow portion 45 side toward the waste liquid tank 48 side. Then, if this tube pump 50 is actuated, the ink stored in the sealed hollow portion 45 can be discharged to the waste liquid tank 48 side by the suction operation. The amount of suction by the tube pump 50 is adjusted by controlling the amount of rotation of the paper feed motor 14, i.e., the amount of rotation of the tube pump 50. In the following description, the operation for imparting a negative pressure to the interior of the sealed hollow portion 45 will be referred to as the forwardly rotating operation, whereas the operation for moving the rollers 55 in the opposite direction thereto will be referred to as the reversely rotating operation. It should be noted that, in this embodiment, the rotating direction can be changed by controlling the paper feed motor 14. In addition, during nonsuction, by performing the reversely rotating operation, as shown in FIG. 6B, control is provided such that the rollers 55 pass through respective guide grooves 56 along the liquid discharging tube 49 and move to the rotating shaft side of the tube pump 50, so as to release the pressurization of the liquid discharging tube 49. It should be noted that, in the printer 1 in accordance with the invention, this reversely rotating operation is performed each time after the suction operation is completed.

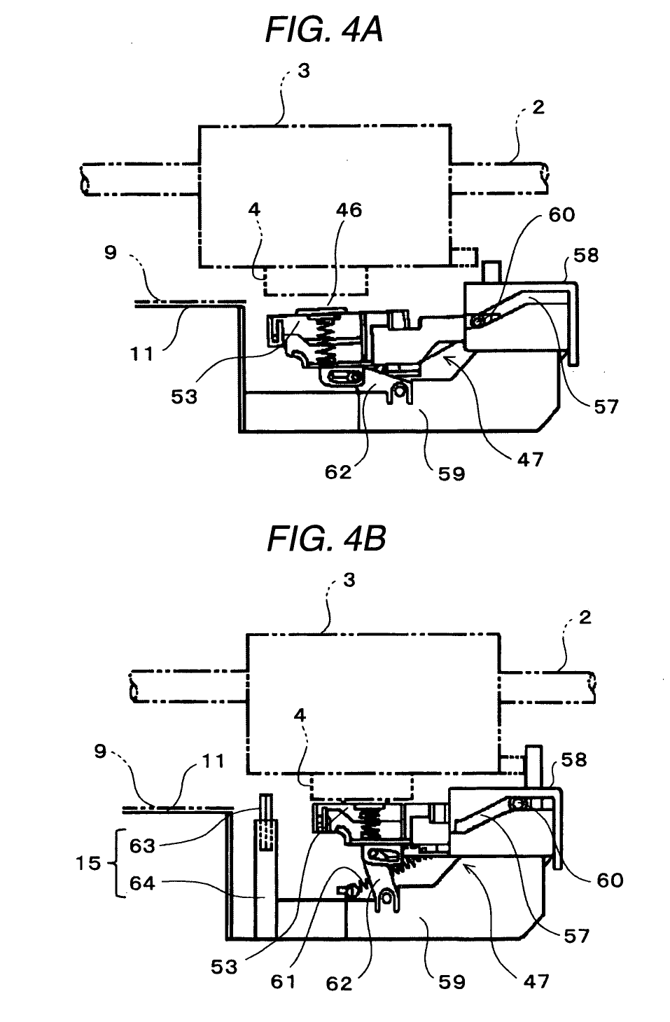

The aforementioned slider mechanism 47 is a mechanism for vertically moving the capping member 46, as described above, and is basically formed by the slider member 53 having the capping member 46 disposed on its upper surface; a holder member 58 having an elongated hole 57 formed in its side surface; and a frame 59 to which the slider member 53 and the holder member 58 are attached. A supporting shaft 60 provided projectingly on the side surface of the slider member 53 is inserted in the elongated hole 57 of the holder member 58 in a movable state. This elongated hole 57 constitutes a cam surface which is low on its platen 11 side and rises higher on the side located further away from the platen 11. In a state in which the carriage 3 is moved away from the home position, the slider member 53 is positioned closer to the platen 11 by being pulled by a spring 61 (in a retreated state shown in FIG. 4A). In this retreated state, the capping member 46 is positioned at a retreated position which is lower than the nozzle surface of the recording head 4. Meanwhile, if the carriage 3 is positioned at the home position, the slider member 53 moves against the tensile force of the spring 61, and the portion on the supporting shaft 60 side rises along the elongated hole 57. In addition, the capping member 46 assumes a state in which it is lifted up by the rotation of an arm member 62. As a result, the capping member 46 moves diagonally upward to seal the nozzle surface (in a sealed state shown in FIG. 4B).

In this sealed state, the nozzle openings 32 of the nozzle surface oppose the sealed hollow portion 45, and the distal end of the capping member 46 and the nozzle surface are brought into close contact with each other in a liquidtight state (see FIG. 5B). Then, if the tube pump 50 is actuated in this sealed state, the interior of the sealed hollow portion 45 is held under negative pressure by the suction operation, so that the ink inside the recording head 4 can be sucked through the nozzle openings 32 and can be discharged to outside the recording head 4. By virtue of such cleaning, it is possible to forcibly discharge the ink whose viscosity has increased in the vicinities of the nozzle openings 32, making it possible to satisfactorily maintain the ejection of ink droplets.

In addition, as also shown in FIG. 4B, the aforementioned wiper mechanism 15 is provided between the slider mechanism 47 and the platen 11. This wiper mechanism 15 is provided with a wiper blade 63, a wiper holder 64, and a wiper moving mechanism (not shown). The wiper blade 63 is a plate-like member made of rubber, for example, and its lower half portion is held by the wiper holder 64. The wiper holder 64 is so constructed as to move horizontally by the wiper moving mechanism and to be capable of advancing and retreating between a wiping position which overlaps the moving path of the recording head 4 and a retreated position which is offset from this moving path. At the wiping position, an upper end portion of the wiper blade 63 is positioned at such a height as to be capable of being brought into sliding contact with the nozzle surface. For this reason, the upper end portion of the wiper blade 63 is brought into sliding contact with the nozzle surface by the movement of the recording head 4 in the main scanning direction, thereby wiping off the ink, paper dust, and the like.

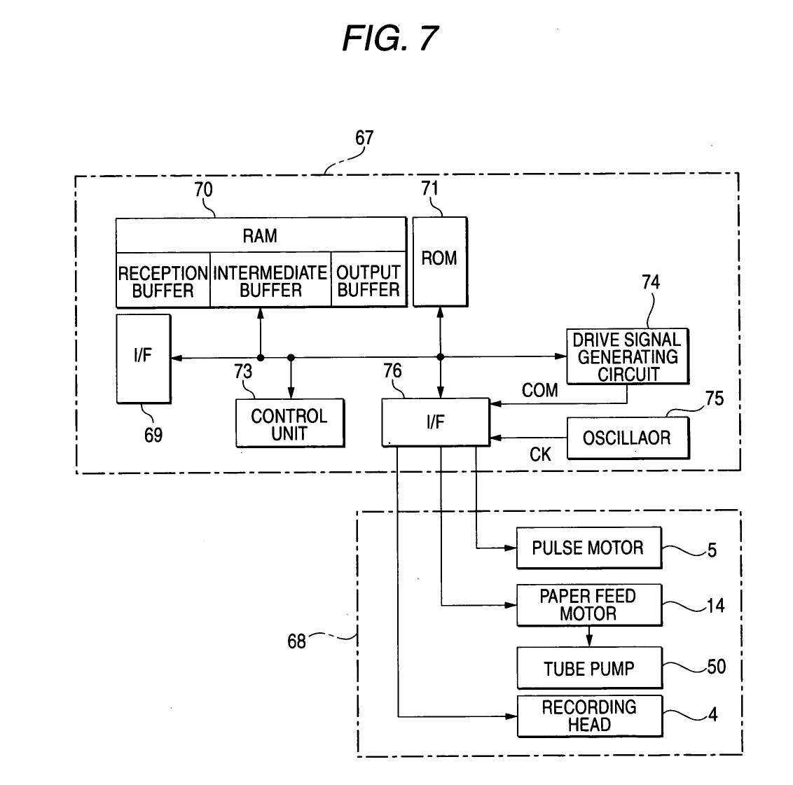

Next, a description will be given of an electric configuration of the printer 1. As shown in FIG. 7, the illustrated printer 1 has a printer controller 67 and a print engine 68. The printer controller 67 has, among others, an interface 69 (external I/F 69) for receiving print data and the like from an unillustrated host computer or the like; a RAM 70 for storing various data; a ROM for storing a control routine and the like for various data processing; a control unit 73 constituted by a CPU and the like; a drive signal generating circuit 74 capable of generating a drive signal which is supplied to the recording head 4; an oscillator 75 for generating a clock signal; and an interface 76 (internal I/F 76) for transmitting such as a dive signal for the recording operation and a control signal for the maintenance operation to the print engine 68 side. These parts are electrically connected to each other via internal buses. Further, the print engine 68 has the pulse motor 5 for moving the carriage 3, the paper feed motor 14 for rotating the paper feed roller 13, the recording head 4 (electric driving system), and the like.

The control unit 73 is a portion for providing control in this printer 1, and controls the various parts of the print engine 68. For example, in control of the recording operation, the control unit 73 generates dot pattern data on the basis of the print data from the unillustrated host computer, and transfers the generated dot pattern data to the recording head 4. Further, the control unit 73 operates the pulse motor 5 to move the carriage 3 (i.e., the recording head 4), and operates the paper feed motor 14 to convey the recording paper 9. Furthermore, the control unit 73 controls such as the pulse moor 4 and the paper feed motor 14 (tube pump 50) also during the cleaning operation and the flushing operation of the recording head 4.

In addition, the control unit 73 also functions as a flushing control unit, and executes the flushing operation for every 2 to 9 seconds, for example, so as to discharge the ink whose viscosity has increased during the recording operation. It should be noted that the flushing interval can be altered, as required, according to the type of ink and the environment.

Next, a description will be given of a first embodiment of the suction operation which is executed after the flushing operation in the above-described configuration. This embodiment is characterized in that the suction operation is executed in two kinds of suction modes (light suction mode and total-amount suction mode) in correspondence with the conditions after the flushing operation.

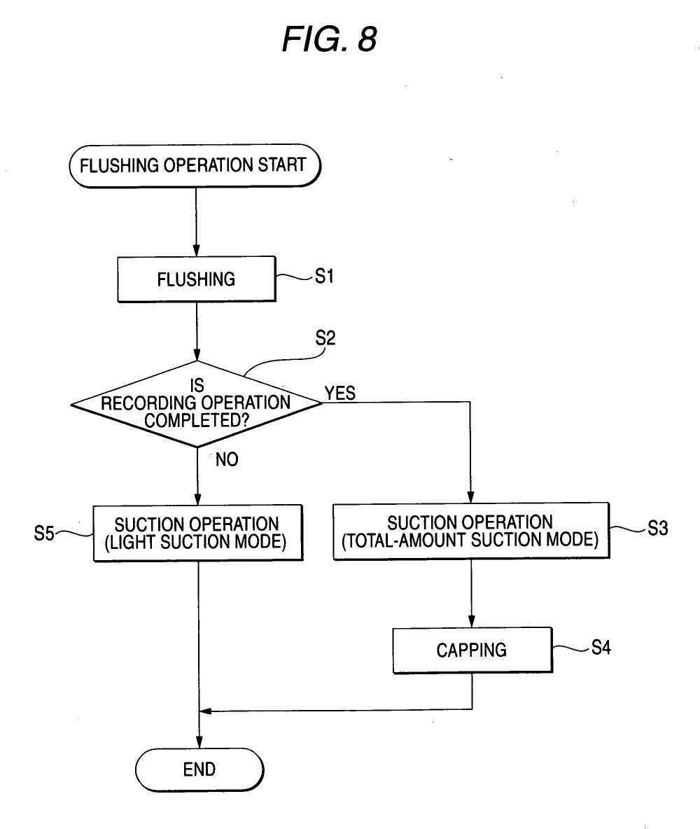

FIG. 8 is a flowchart explaining the processing from a flushing operation start until the completion of the suction operation. Upon determining that the execution timing of the flushing operation has arrived, the control unit 73 executes the flushing operation in Step S1.

Then, upon completion of the flushing operation, in Step S2, the control unit 73 functions as a suction control unit, and determines whether or not the printer has completed the recording operation. If it is determined that the recording operation has been completed, the operation proceeds to the processing of Step S3 to execute the suction operation in the total-amount suction mode. In this case, the control unit 73 effects the suction operation in the total-amount suction mode by controlling the paper feed motor 14 so as to rotate the tube pump 50 by 10 turns, for example. The amount of suction in this total-amount suction mode is set to not less than an amount by which the ink in the capping member 46 and the ink inside the liquid discharging tube 49 in the pump mechanism can be discharged, i.e., to not less than an amount which combines the volume in the capping member 46 and the volume inside the liquid discharging tube 49 in the pump mechanism. Accordingly, if the suction operation is effected in the total-amount suction mode, all the ink remaining in the capping member 46 and inside the liquid discharging tube 49 can be discharged. For this reason, it is possible to prevent in advance malfunctions such as a decline in the suction force of the pump mechanism and the closure of the interior of the liquid discharging tube 49 due to the solidification of the ink remaining in the capping member 46 and inside the liquid discharging tube 49.

Next, in Step S4, the control unit 73 moves the carriage 3 to the home position, and moves the slider member 53 diagonally upward by the rotation of the arm 62. As a result, capping is effected in which the capping member 46 is moved diagonally upward, and is brought into close contact with the nozzle surface to assume a sealed state. After this capping, the printer 1 is set in the standby mode. If the suction operation is thus executed in the total-amount suction mode before effecting sealing by the capping member after the completion of the ejection operation, the ink does not remain inside the liquid discharging tube 49 over a long period of time due to the standby state of the printer 1 or the turning off of the power supply, so that there is no possibility of the ink flowing backward into the capping member 46 and adhering to the nozzle surface. Accordingly, it is possible to prevent in advance the malfunctions such as faulty ejection.

On the other hand, if it is determined in Step S2 that the recording operation has not been completed, i.e., if it is determined that the recording operation is underway, the operation proceeds to the processing in Step S5. In this case, the control unit 73 executes the suction operation by selecting the light suction mode which is executed during the recording operation. The amount of suction in this light suction mode is set to be smaller than the amount of suction in the above-described total-amount suction mode. Specifically, the amount of suction in this light suction mode is set to an amount of suction for sucking by not less than the volume in the capping member 46 by controlling the paper feed motor 14 so as to rotate the tube pump 50 by 1 to 3 turns, for example. If such a setting is provided, the ink does not remain in the capping member 46, so that there is no possibility of causing malfunctions such as faulty ejection due to the adhesion of the ink to the nozzle surface even if the suction operation or the like is performed during cleaning or the recording operation. In addition, by setting the amount of suction in the light suction mode to be smaller than that in the total-amount suction mode, the amount of work of the pump mechanism during a single suction operation can be reduced. As a result, the load in pressing the liquid discharging tube 49 due to the squeezing by the rollers 55 of the pump mechanism can be alleviated, and the burdens of the paper feed motor 14 and the power transmission mechanism can also be alleviated. Accordingly, it is possible to suppress the deterioration of the pump mechanism and the like.

In addition, the amount of suction in this light suction mode may be set to be not greater than the volume in the capping member 46. Specifically, in Step S2, the amount of suction in this light suction mode is set to an amount of suction which is capable of discharging all the ink stored in the capping member 46 in a single flushing operation. In this case, the control unit 73 controls the paper feed motor 14 so as to rotate the tube pump 50 by a ⅕ turn, for example. Consequently, the ink does not remain in the capping member 46, so that there is no possibility of causing malfunctions such as faulty ejection due to the adhesion of the ink to the nozzle surface even if the suction operation or the like is performed during cleaning or the recording operation. In addition, by providing such a setting, the amount of work of the pump mechanism during a single suction operation can be substantially reduced. As a result, the load in pressing the liquid discharging tube 49 due to the squeezing by the rollers 55 of the pump mechanism can be alleviated further, and the burdens of the paper feed motor 14 and the power transmission mechanism can also be alleviated further. Accordingly, it is possible to further suppress the deterioration of the pump mechanism and the like.

In particular, in this setting, the advantages are noticeable in the case of a large-print type printer. The reason for this is that, in the large-print type printer, since the liquid discharging tube 49 is longer than that that of an ordinary printer, the proportion of the amount of suction of the volume portion inside the liquid discharging tube 49 in the amount of suction in the total-amount suction mode is greater than in the case of the ordinary printer. For this reason, in the total-amount suction mode, the proportion of the amount of work of the pump mechanism for the volume portion inside the liquid discharging tube 49 also becomes large. Further, in this setting, in the light suction mode, since the amount of suction is set to be not greater than the volume in the capping member 46, it is possible to reduce the amount of work of the pump mechanism for the volume portion inside the liquid discharging tube 49. Namely, the proportion of the amount of work of the pump mechanism which can be reduced in the total-amount suction mode becomes large. Accordingly, the load in pressing the liquid discharging tube 49 due to the squeezing by the rollers 55 of the pump mechanism can be alleviated substantially, and the burdens of the paper feed motor 14 and the power transmission mechanism can also be alleviated even further. Accordingly, it is possible to even further suppress the deterioration of the pump mechanism and the like.

In addition, in the light suction mode, the pressing of the liquid discharging tube 49 by the rollers 55 may not be released during nonsuction. Namely, the reversely rotating operation which is performed each time after the completion of the suction operation during the recording operation may not be carried out. If such an arrangement is provided, it is possible to reduce the amount of work of the pump mechanism during the reversely rotating operation. As a result, since the burdens on the paper feed motor 14 and the power transmission mechanism can be alleviated, it is possible to further suppress the deterioration and the like of the pump mechanism.

Then, upon completion of the suction operation in the light suction mode, the printer returns to the recording operation again.

Next, a description will be given of a second embodiment of the suction operation which is executed after the above-described flushing operation. This embodiment is characterized in that the light suction mode in the above-described first embodiment is executed in a case where the amount of ink calculated by a liquid storage amount calculating unit during the recording operation has reached a predetermined amount, and that the predetermined amount is set to not greater than the amount of suction in the light suction mode.

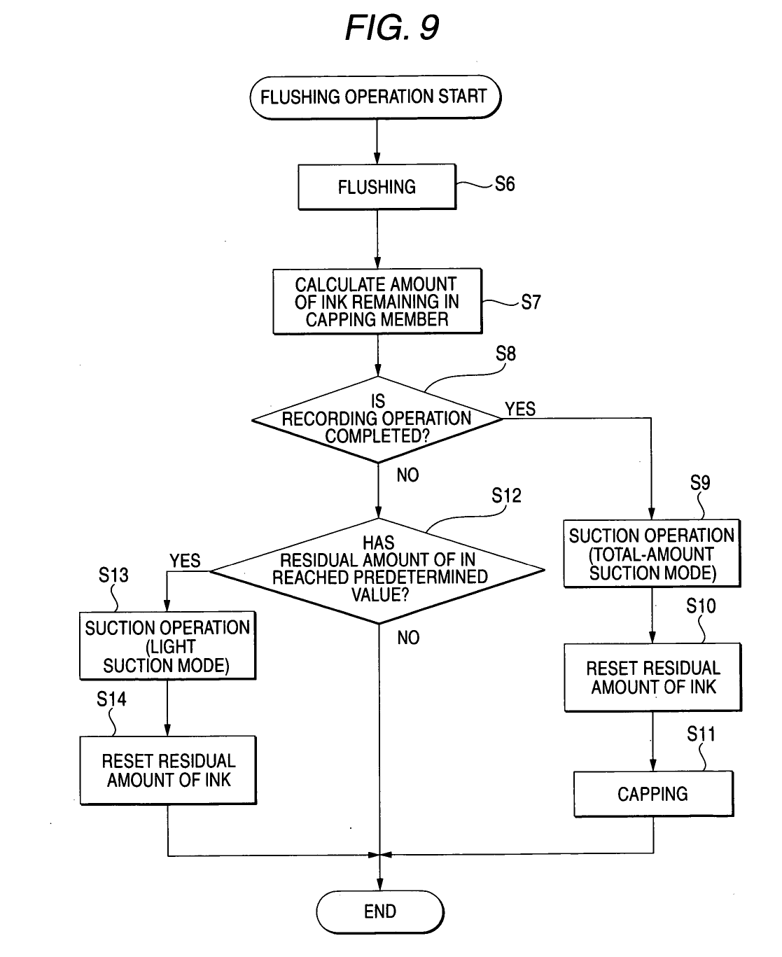

FIG. 9 is a flowchart explaining the processing from the flushing operation, which is executed by providing the liquid storage amount calculating unit in the above-described first embodiment, until the completion of the suction operation. The control unit 73 functions as the flushing control unit in the same way as in the first embodiment, and upon determining that the execution timing of the flushing operation has arrived, the control unit 73 executes the flushing operation in Step S6.

Then, in Step S7, the liquid storage amount calculating unit calculates the amount of ink ejected by the flushing operation executed in Step S6, and adds it to the amount of ink stored in the capping member 46 by the flushing operations up until the most recent one, thereby calculating the present amount of ink stored in the capping member 46. This value is stored in the RAM 70.

Next, in step S8, the control unit 73 functions as the suction control unit, and determines whether or not the printer has completed the recording operation. If it is determined that the recording operation has been completed, the control unit 73 executes the suction operation in the total-amount suction mode (Step S9). In the same way as in the first embodiment, if the suction operation is effected in the total-amount suction mode, all the ink remaining in the capping member 46 and inside the liquid discharging tube 49 can be discharged. For this reason, it is possible to prevent in advance malfunctions such as a decline, in the suction force of the pump mechanism and the closure of the interior of the liquid discharging tube 49 due to the solidification of the ink remaining in the capping member 46 and inside the liquid discharging tube 49.

In Step S10, the amount of ink remaining in the capping member 46, which has been calculated by the liquid storage amount calculating unit, is reset, i.e., the value of the amount of ink stored in the RAM 70 is set to zero. As a result, the actual amount of ink (zero) in the capping member 46 and the amount of ink calculated by the liquid storage amount calculating unit are made to agree.

Then, in Step S11, the control unit 73 moves the carriage 3 to the home position, and moves the slider member 53 diagonally upward by the rotation of the arm 62. As a result, capping is effected in which the capping member 46 is moved diagonally upward, and is brought into close contact with the nozzle surface to assume a sealed state. After this capping, the printer 1 is set in the standby mode. In this case as well, in the same way as in the first embodiment, since the suction operation is executed in the total-amount suction mode before effecting sealing by the capping member after the completion of the ejection operation, the ink does not remain inside the liquid discharging tube 49 over a long period of time due to the standby state of the printer 1 or the turning off of the power supply. Hence, there is no possibility of the ink flowing backward into the capping member 46 and adhering to the nozzle surface. Accordingly, it is possible to prevent in advance the malfunctions such as faulty ejection.

On the other hand, if it is determined in Step S8 that the recording operation has not been completed, i.e., if it is determined that the recording operation is underway, the operation proceeds to the processing in Step S12.

In Step S12, a determination is made as to whether or not the residual amount of ink calculated in Step S7 has reached a predetermined value, and if the predetermined value has been reached, the operation proceeds to Step S13. In this case, the control unit 73 functions as the suction control unit, and executes the suction operation by selecting the light suction mode. The amount of suction in this light suction mode is set to be smaller than the amount of suction in the above-described total-amount suction mode. Specifically, the amount of suction in this light suction mode is set to an amount of suction for sucking by not less than the volume in the capping member 46 by controlling the paper feed motor 14 so as to rotate the tube pump 50 by 1 to 3 turns, for example. In the same way as in the first embodiment, the ink does not remain in the capping member 46, so that there is no possibility of causing malfunctions such as faulty ejection due to the adhesion of the ink to the nozzle surface even if the suction operation or the like is performed during cleaning or the recording operation. In addition, by setting the amount of suction in the light suction mode to be smaller than that in the total-amount suction mode, the amount of work of the pump mechanism during a single suction operation can be reduced. As a result, the load in pressing the liquid discharging tube 49 due to the squeezing by the rollers 55 of the pump mechanism can be alleviated, and the burdens of the paper feed motor 14 and the power transmission mechanism can also be alleviated. Accordingly, it is possible to suppress the deterioration of the pump mechanism and the like.

In addition, the amount of suction in this light suction mode may be set to be not greater than the volume in the capping member 46. Specifically, in Step S6, the amount of suction in this light suction mode is set to an amount of suction which is capable of discharging all the ink stor5ed in the capping member 46 in a single flushing operation. In this case, the control unit 73 controls the paper feed motor 14 so as to rotate the tube pump 50 by a ⅕ turn, for example. Consequently, the ink does not remain in the capping member 46, so that there is no possibility of causing malfunctions such as faulty ejection due to the adhesion of the ink to the nozzle surface even if the suction operation or the like is performed during cleaning or the recording operation. In addition, by providing such a setting, the amount of work of the pump mechanism during a single suction operation can be substantially reduced. As a result, the load in pressing the liquid discharging tube 49 due to the squeezing by the rollers 55 of the pump mechanism can be alleviated further, and the burdens of the paper feed motor 14 and the power transmission mechanism can also be alleviated further. Accordingly, it is possible to further suppress the deterioration of the pump mechanism and the like.

In this setting, the advantages are noticeable in the case of a large-print type printer in the same way as in the first embodiment. The reason for this is that, in the large-print type printer, since the liquid discharging tube 49 is longer than that that of an ordinary printer, the proportion of the amount of suction of the volume portion inside the liquid discharging tube 49 in the amount of suction in the total-amount suction mode is greater than in the case of the ordinary printer. For this reason, in the total-amount suction mode, the proportion of the amount of work of the pump mechanism for the volume portion inside the liquid discharging tube 49 also becomes large. Further, in this setting, in the light suction mode, since the amount of suction is set to be not greater than the volume in the capping member 46, it is possible to reduce the amount of work of the pump mechanism for the volume portion inside the liquid discharging tube 49. Namely, the proportion of the amount of work of the pump mechanism which can be reduced in the total-amount suction mode becomes large. Accordingly, the load in pressing the liquid discharging tube 49 due to the squeezing by the rollers 55 of the pump mechanism can be alleviated substantially, and the burdens of the paper feed motor 14 and the power transmission mechanism can also be alleviated even further. Accordingly, it is possible to even further suppress the deterioration of the pump mechanism and the like.

In addition, in the light suction mode, the pressing of the liquid discharging tube 49 by the rollers 55 may not be released during nonsuction. Namely, the reversely rotating operation which is performed each time after the completion of the suction operation during the recording operation may not be carried out. Consequently, it is possible to reduce the amount of work of the pump mechanism during the reversely rotating operation, so that it is possible to further suppress the deterioration of the pump mechanism.

Then, in Step S14, in the same way as Step S10, the amount of ink remaining in the capping member 46, which has been calculated by the liquid storage amount calculating unit, is reset, i.e., the value of the amount of ink stored in the RAM 70 is set to zero. As a result, the actual amount of ink (zero) in the capping member 46 and the amount of ink calculated by the liquid storage amount calculating unit are made to agree.

Then, if the resetting of the amount of ink remaining in the capping member 46 in this Step S14 is completed, the printer returns to the recording operation again.

On the other hand, if it is determined in Step S12 that the residual amount of ink calculated in Step S7 has not reached the predetermined value, the suction operation is not performed, and the printer 1 returns to the recording operation.

According to this embodiment, the following advantages are offered in addition to the advantages of the first embodiment. Since the suction control unit executes the light suction mode during the recording operation in the case where the amount of liquid calculated by the liquid storage amount calculating unit has reached a predetermined amount, it is possible to reduce the number of times of execution of the suction operation in the light suction mode. Consequently, it is possible to prolong the interval until an ensuing suction operation is performed after the most recent suction operation has been performed during the ejection operation. Namely, it is possible to prolong the state of shutdown of the pump mechanism. Accordingly, the load in pressing the liquid discharging tube 49 due to the squeezing by the rollers 55 of the pump mechanism can be alleviated further, and the burdens of the paper feed motor 14 and the power transmission mechanism can also be alleviated further. Accordingly, it is possible to even further suppress the deterioration of the pump mechanism. Further, by setting the difference between the predetermined amount and the amount of suction in the light suction mode can be set to be small, it is possible to enhance the suction efficiency in the light suction mode. Namely, since it is possible to reduce wasteful suction operation such as the suction of the air after having fully discharged the ink, the amount of work of the pump mechanism can be reduced by that portion. Accordingly, the load in pressing the liquid discharging tube 49 due to the squeezing by the rollers 55 of the pump mechanism can be alleviated further, and the burdens of the paper feed motor 14 and the power transmission mechanism can also be alleviated further. Accordingly, it is possible to even further suppress the deterioration of the pump mechanism.

In addition, although a description has been given above by citing by way of example the ink jet printer 1 which is one kind of liquid ejecting apparatus, the invention is applicable to other liquid ejecting apparatuses. For example, the invention is also applicable to a display manufacturing apparatus for manufacturing a color filter for such as a liquid crystal display, an electrode manufacturing apparatus for forming electrodes of an organic EL (electro luminescence) display, an FED (field emission display), and the like, a chip manufacturing apparatus for manufacturing a biochip, and a micropippet for supplying a very small amount of a sample solution by an accurate amount.

What is claimed is:

1. A liquid ejecting apparatus comprising:
a liquid ejection head capable of ejecting a liquid droplet from a nozzle opening provided in a nozzle surface;
a capping member capable of sealing the nozzle opening with a capping member being in close contact with a nozzle surface;
a flushing control unit for idly ejecting a liquid droplet from the nozzle opening toward the capping member;
a pump mechanism that communicates with the capping member through a liquid channel; and
a suction control unit for effecting control of sucking liquid from inside the capping member through the liquid channel by actuating the pump mechanism,
wherein the suction control unit is capable of executing a light suction mode which is executed during an ejection operation and a total-amount suction mode which is executed before effecting sealing by the capping member after the ejection operation,
wherein a suction amount in the total-amount suction mode is set to not less than such an amount as to be capable of discharging liquid in the capping member and liquid inside the liquid channel, and
wherein a suction amount in the light suction mode is set to be smaller than the suction amount in the total-amount suction mode.

2. The liquid ejecting apparatus according to claim 1, further comprising a liquid storage amount calculating unit for calculating a liquid amount stored in the capping member under control by the flushing control unit,
wherein the suction control unit executes the light suction mode operation when the liquid amount has reached a predetermined amount, and
wherein the predetermined amount is set to not more than the suction amount in the light suction mode.

3. The liquid ejecting apparatus according to claim 1, wherein the suction amount in the light suction mode is set to not greater than a volume in the capping member.

4. The liquid ejecting apparatus according to claim 2, further comprising a memory for storing the calculated liquid amount.

5. A liquid ejecting control method used in a liquid ejecting control apparatus comprising:
a liquid ejection head capable of ejecting a liquid droplet from a nozzle opening provided in a nozzle surface;
a capping member capable of sealing the nozzle opening with a capping member being in close contact with a nozzle surface;
a flushing control unit for idly ejecting a liquid droplet from the nozzle opening toward the capping member;
a pump mechanism that communicates with the capping member through a liquid channel; and
a suction control unit for effecting control of sucking liquid from inside the capping member through the liquid channel by actuating the pump mechanism, the method comprising:
performing ejection operation;
performing flushing operation during the ejection operation;
detecting whether the ejection operation is finished or not;
when the ejection operation is finished, performing a total-amount suction mode whose suction amount is set to not less than such an amount as to be capable of discharging liquid in the capping member and liquid inside the liquid channel; and
when the ejection operation is not finished, performing a light suction mode whose suction amount is set to be smaller than the suction amount in the total-amount suction mode.

6. The liquid ejecting method according to claim 5, wherein the suction amount in the light suction mode is set to not greater than a volume in the capping member.

7. The liquid ejecting method according to claim 5, further comprising capping the nozzle opening by the capping member after performing the total-amount suction mode.

8. A liquid ejecting control method used in a liquid ejecting control apparatus comprising:
a liquid ejection head capable of ejecting a liquid droplet from a nozzle opening provided in a nozzle surface;
a capping member capable of sealing the nozzle opening with a capping member being in close contact with a nozzle surface;
a flushing control unit for idly ejecting a liquid droplet from the nozzle opening toward the capping member;
a pump mechanism that communicates with the capping member through a liquid channel;
a suction control unit for effecting control of sucking liquid from inside the capping member through the liquid channel by actuating the pump mechanism, and
a liquid storage amount calculating unit for calculating a liquid amount stored in the capping member under control by the flushing control unit, the method comprising:
performing ejection operation;
performing flushing operation during the ejection operation;
calculating the liquid amount stored in the capping member;
detecting whether the ejection operation is finished or not;
when the ejection operation is finished, performing a total-amount suction mode whose suction amount is set to not less than such an amount as to be capable of discharging liquid in the capping member and liquid inside the liquid channel; and
when the ejection operation is not finished, determining whether a light suction mode whose suction amount is set to be smaller than the suction amount in the total-amount suction mode is executed or not based on the liquid amount stored in the capping member.

9. The liquid ejecting method according to claim 8, wherein the method further comprises:
after the total-amount suction mode is executed, resetting the liquid amount and capping the nozzle opening by the capping member.

10. The liquid ejecting method according to claim 8, wherein the method further comprises:
when the ejection operation is not finished, detecting whether the liquid amount has reached a predetermined amount or not; and
when the liquid amount has reached the predetermined amount, performing the light suction mode and then resetting the liquid amount.

11. The liquid ejecting apparatus according to claim 8, wherein the suction amount in the light suction mode is set to not greater than a volume in the capping member.

12. The liquid ejecting apparatus according to claim 10, wherein the predetermined amount is set to not more than the suction amount in the light suction mode.
